(19) United States
(12) Patent Application Publication
(10) Pub. No.: US 2019/0240930 A1
(43) Pub. Date: Aug. 8, 2019

(54) LASER PROCESSING CONTROL FOR AUTOMATED COMPOSITE PLACEMENT

(71) Applicant: United States of America as represented by the Secretary of the Army, Washington, DC (US)

(72) Inventor: Adam T. Roberts, Torrance, CA (US)

(21) Appl. No.: 15/888,234

(22) Filed: Feb. 5, 2018

(51) Int. Cl. B29C 70/38; B29C 35/08

(52) U.S. Cl. CPC B29C 70/388; B29C 2035/0838; B29C 35/0805

(57) ABSTRACT

The application relates to a method (and a related machine) for making a composite part by automated fiber placement, comprising the steps of: pre-heating a composite tape with a pre-heating laser source, thus generating a thermal image of the pre-heated tape; transforming the pre-heated thermal image into a control signal controlling a laser array; heating a portion of the composite tape at the compaction point with the laser array being controlled by the control signal; and placing the portion of the heated composite tape onto a form tool and compressing the tape to adhere onto the substrate surface of the tool.

### BACKGROUND

Using lasers or infrared radiation to melt thermoplastic composites is known. Several inventions are known that use a single heat source or a collection of heat sources that are combined with a single control to melt thermoplastic composites. It is also known to use a laser array to administer and control the heat to melt the thermoplastic composites and to include a detector to provide feedback for the laser array. Several examples of laser welding and heating composites use a reactive feedback loop. The reactive feedback detection loop will only control for material that has already been heated and welded together. Therefore, any thermal gradients or inconsistencies in the material are not corrected until after the material has already been processed.

### BRIEF DESCRIPTION OF THE DRAWINGS

FIG. 1 is an overview of the system components of the present application.

FIG. 2 is a view of the composite tape of the present application.

FIG. 3 is a sample temperature distribution curve extracted based on the arrangement of FIG. 2.

FIG. 4 is a control signal derived from the temperature distribution curve of FIG. 3, the control signal reflecting the arrangement of FIG. 3.

FIG. 5 is a graph which shows the individual lasers' outputs in the array and how the outputs are positionally arranged based on the control signal.

FIG. 6 graphically shows the temperature distribution measured at the pre-heat beam site and at the laser array site.

FIG. 7 shows the components of an embodiment of the laser system that has two laser arrays and two pre-heat lasers.

FIG. 8 shows both the composite tape and substrate as they feed into the compaction point based on the arrangement in FIG. 7.

### DETAILED DESCRIPTION

The present application relates to a system for controlling a laser array to effectively heat and press composite materials into a substrate in an automated fiber placement machine.

The automated fiber placement machine of the present invention builds composite parts including, but not limited to, rocket motors, launchers, or aircraft components. The use of this invention is not part specific, but process specific. It is designed for additively building composite parts of any sort via in-situ consolidation.

One of the key differences from the prior art is the fact that the present application incorporates a pre-heat laser beam to pre-heat the composite materials. This pre-heating of the composite materials generates a predictive control signal for the laser array. When the materials achieve the target processing temperature from the laser array which has been corrected for individual gradients or inconsistencies by the application of the predictive control signal, the resultant composite tape which is pressed together with a substrate has much higher quality consolidation between layers. To achieve this, the composite materials are pre-heated before they reach the location in the process where they are heated by the laser array. This pre-heating results in the composite materials with their individual gradients and inconsistencies then being heated by the laser array to the desired processing temperature just before being pressed together with the substrate by the compaction roller. Any deviations in the measured temperature of the pre-heated composite materials are measured by an infrared imaging detector and the measurements are then used to increase or decrease the power of the individual laser elements in the laser array. The laser array power distribution of the individual elements is thus determined by measurements of the pre-heat temperature distribution of various parts of the pre-heated composite material just before the material passes from the pre-heated beam location to the laser array beam location. By measuring and using the pre-heat temperature distribution of the composite materials, inconsistencies in the material or other thermal gradients can be detected accordingly before the material receives beams transmitted by the individual elements of the laser array onto the tape. This is achieved by causing the individual elements of the laser array to increase or decrease in laser power according to the various measured temperatures of individual designated portions of the pre-heated composite materials. The resulting predictive control signal helps attain material processing consistency.

A second advantage to the pre-heat technique is that the physical spacing between the pre-heat beam location and the laser array beam location creates the time delay between when a given defect is detected at the pre-heat location and the arrival of that same defect at the laser array beam site. The time delay aspect of the present invention works well with most standard infrared imaging detectors which generally have a frame rate that is limited to 200 Hz or less. Based on the physical formula λ=C/f, if the processing speed of an automated placement machine is 1 meter per second (C), and the detector operates at 200 Hz (f), this creates a 5 mm separation (λ) between the pre-heat beam and the laser array beam. This 5 mm separation allows the laser array to be adjusted and fine-tuned, based on the pre-heat temperature distribution. This 5 mm separation is, in turn, enabled by the 200 Hz rate of a standard infrared detector. Thus, the often occurring 200 Hz rate system allows time for the adjustment of the laser array output before the specific defects in the tape arrive at the laser array beams at which time it is too late for such corrections.

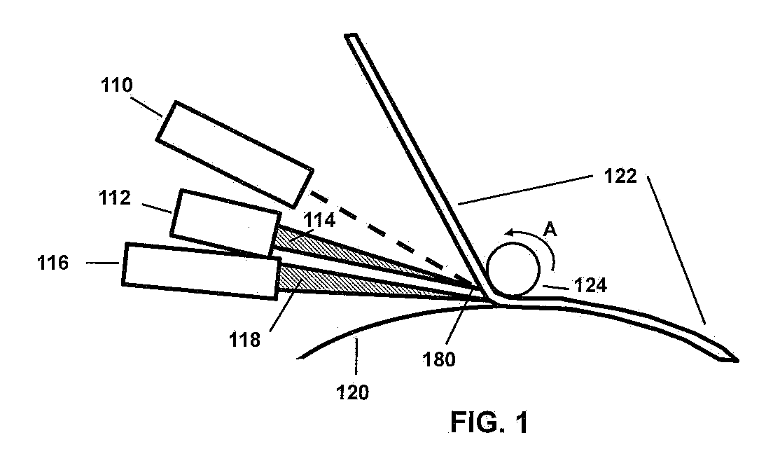

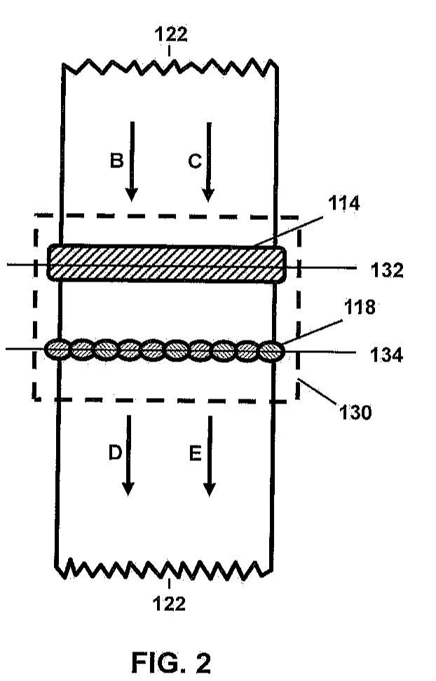

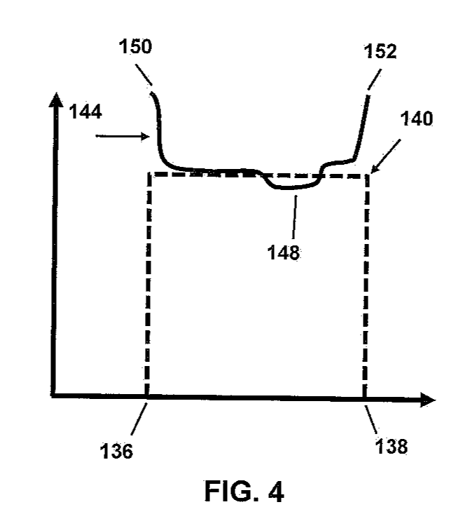

FIG. 1 depicts an embodiment of the present invention which has a laser system that has one pre-heat laser source 112 and one laser array 116 for heating the composite tape 122. In this setup, the pre-heat laser 112 is positioned to produce the pre-heat laser beam(s) 114 on the tape 122 at a given distance before the compaction roller 124 presses the tape 122 and substrate 120 together. Furthermore, the laser array 116 is positioned to produce laser array beam(s) 118 on the tape 122, immediately before the compaction roller 124 presses the tape 122 and the substrate 120 together. The infrared detector 110 registers an image of the pre-heat beam temperature distribution line 132 (shown in FIG. 2) across the tape 122 heated by the pre-heat laser beam 114, the infrared detector 110 thus generating the control signal 144 (shown in FIG. 4) for the laser array 116, which, in turn, generates the laser array beam(s) 118 on the tape 122. Arrow “A” indicates the rotational direction of the compaction roller 124.

FIG. 2 is a view of the composite tape 122 as it passes the pre-heat laser beam(s) 114 and the laser array beam(s) 118 on the way to the compaction point 180. The arrows “B”, “C”, “D” and “E” indicate the direction of travel of the composite tape 122. The pre-heat laser beam(s) 114 and the laser array beam(s) 118 are in fixed locations, while the composite tape 122 is travelling from a spool (not depicted) to the compaction point 180. The dashed box 130 depicts the field of view of the infrared thermal detector 110. FIG. 2 also shows the location of the pre-heat beam temperature distribution line 132 from which the infrared detector 110 creates the control signal 144 (shown in FIG. 4) that feeds forward to the laser array 116 and subsequently to the laser array beam(s) 118. FIG. 2 also shows the location on the tape 122 of the laser array temperature distribution line 134 where the final processing temperatures of the tape 122 are reached before the tape 122 is pressed by the compaction roller 124 into the substrate 120.

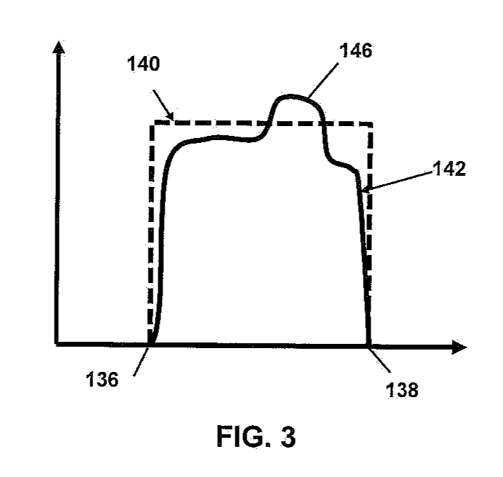

FIG. 3 shows a graph plotting temperature (Y) vs. distribution on the feedstock (X) that is extracted from the image registered by the infrared detector 110 at the pre-heat beam temperature distribution line 132 from FIG. 2. The measured pre-heat temperature distribution curve 142 includes the various measured temperatures that individual designated portions of the pre-heat beam temperature distribution line 132 of the composite tape 122 reach after being heated by the pre-heat laser beam 114. The temperature points of the two ends of the pre-heat beam temperature distribution line 132 of the tape 122 are represented at 136 and 138 of the pre-heat temperature distribution curve 142. The target temperature of the tape 122 desirable for pressing into the substrate 120 is indicated by the dashed line 140. In this example, the two temperature endpoints of the pre-heat beam temperature distribution line 132 of the tape 122 correspond to the two ends 136, 138 of the pre-heat temperature distribution thermal image curve 142. These two ends 136, 138 are at a minimum temperature and there is a portion 146 of the pre-heat temperature distribution thermal image curve 142 at a maximum temperature that is above the target temperature represented by the dash line 140. The difference between the dash line target temperature 140 and the temperatures of the measured pre-heat temperature distribution thermal image curve 142 is the basis for creating the control signal 144 (shown in FIG. 4) for the laser array 116.

FIG. 4 shows a graph plotting temperature (6) vs. distribution on the feedstock (X). Specifically, FIG. 4 shows the control signal 144 that resembles a mirror image of the sample pre-heat temperature distribution thermal image curve 142 in FIG. 3, i.e., the high points of FIG. 4 being reflective of the low points of FIG. 3 and the low points of FIG. 4 being reflective of the high points of FIG. 3. In turn, FIG. 3 is extracted from temperature values included in the pre-heat beam temperature distribution line 132 in FIG. 2. The two low temperature points 136, 138 that had minimum temperatures in pre-heat thermal image curve 142 in FIG. 3 require increased power from the laser array beam 118 coming from the power of the laser array 116 as generated from the control signal 144 of FIG. 4. This requirement for increased laser power in the low temperature points 136 and 138 results in the left and right maximum end 150, 152 of the control signal 144 for the laser array 116. It also results in the approximately middle portion 146 of the pre-heat temperature distribution thermal image curve 142 that had a higher temperature than the target temperature (dashed line) 140 in FIG. 3 needing substantially less power from the laser array beams 118 of the laser array 116. This is shown in FIG. 4, where the approximately middle portion 148 of the control signal 144 extends below the dashed line 140, and the dashed line 140 indicates the target temperature.

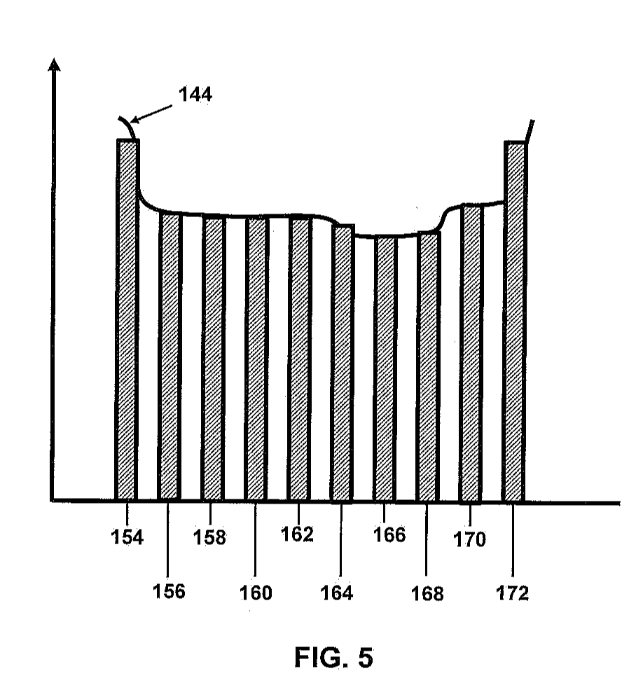

FIG. 5 shows a graph plotting Drive Current (Y) vs. individual laser outputs (X), the order of the outputs being based on their successive positions in the laser array 116 itself. The graph of FIG. 5 demonstrates how the individual lasers' outputs 154, 156, 158, 160, 162, 164, 166, 168, 170, & 172 positioned successively in the laser array 116 are driven with different individual currents based on the control signal 144. Even though FIG. 5 depicts a laser array 116 of ten individually controllable lasers with separate laser outputs 154, 156, 158, 160, 162, 164, 166, 168, 170, & 172, this number of laser outputs is exemplary and not intended to limit the number of outputs that can be used in the present application.

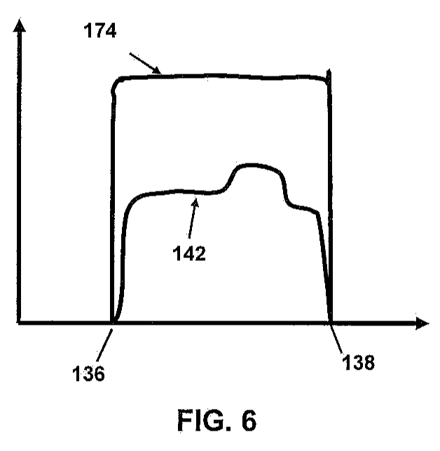

FIG. 6 shows a graph plotting temperatures (Y) vs. distribution on the feedstock (X) of the various temperatures. The graph displays two curves corresponding to the pre-heat temperature distribution thermal image curve 142 and to the laser array temperature distribution line 174 after the predictive temperature control signal 144 has been implemented with the individually controllable laser outputs 154, 156, 158, 160, 162, 164, 166, 168, 170, & 172.

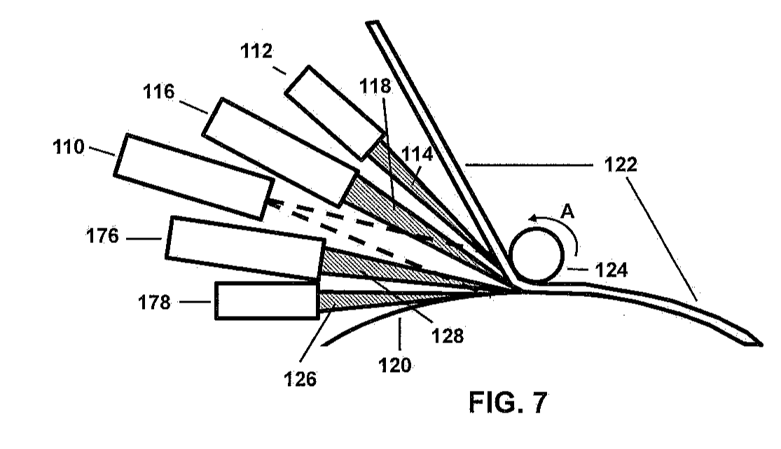

FIG. 7 depicts an embodiment of the present application which has a laser system with two laser arrays 116, 176 and two pre-heat lasers 112, 178 simultaneously heating the composite tape 122 and the substrate 120. In this setup, the pre-heat laser 112 is positioned to produce the pre-heat laser beam(s) 114 on the tape 122 at a given distance before the compaction roller 124 presses the tape 122 and substrate 120 together. By the same token, the pre-heat laser 178 is positioned to produce the pre-heat laser beam(s) 126 on the substrate 120 at the same given distance before the compaction roller 124 presses the tape 122 and substrate 120 together. Furthermore, the laser array 116 is positioned to produce laser array beams 118 on the tape 122 immediately before the compaction roller 124 presses the tape 122 and substrate 120 together. By the same token, the laser array 176 is positioned to produce laser array beams 128 respectively on the substrate 120, immediately before the compaction roller 124 presses the tape 122 and the substrate 120 together. The infrared detector 110 registers an image of the preheated portions of the tape 122 and the preheated portions of the substrate 120 as they are heated by the pre-heat laser beams 114 for the tape 122 and the preheat laser beam 126 for the substrate 120. The images generate the respective control signals 144 for laser arrays 116 for the tape 122 and laser array 176 for the substrate 120. The laser array 116 for the tape 122 and the laser array 176 for the substrate 120 in turn generate the laser array beams 118 for the tape 122 and the laser array beam 128 for the substrate 120. Arrow “A” indicates the rotational direction of the compaction roller 124.

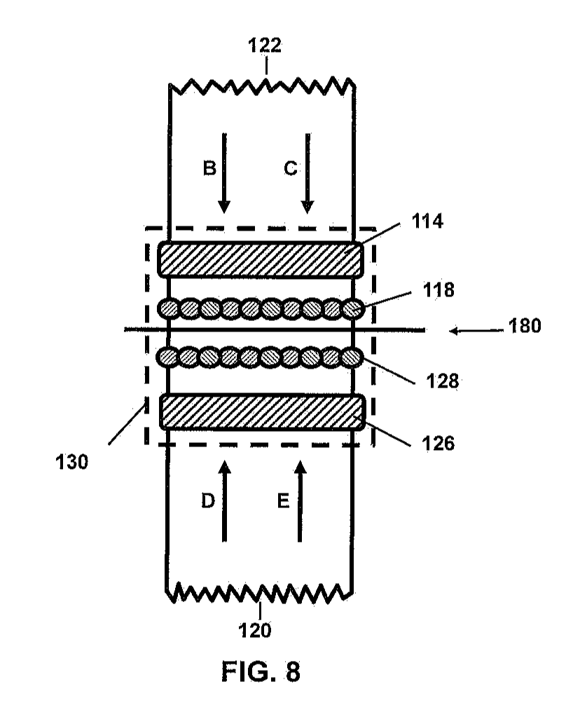

FIG. 8 depicts the composite tape 122 and substrate 120 as they feed into the compaction point 180 consistent with the setup in FIG. 7. FIG. 8 shows the placement of the respective pre-heat laser beams 114 and 126 and the respective laser array beams 118 and 128. It also portrays in a dashed line rectangle 130 the area of the thermal image captured by the infrared detector 110. The arrows “B” and “C” indicate the direction of travel of the composite tape 122. The arrows “D” and “E” indicate the direction of travel of the substrate 120 towards the compaction point 180.

The present invention relates to a method of making a composite part by automated fiber placement with a compaction roller 124, comprising the steps of:

pre-heating a composite tape 122 to be adhered to a substrate surface 120 by beaming with a pre-heating laser source 122 a pre-heating laser beam 114 at least 5 mm before the composite tape 122 reaches a compaction point 180 with the compaction roller 124, the pre-heating producing a pre-heat beam temperature distribution line 132 across the pre-heated composite tape 122;

registering with an infrared detector 110 an image of the pre-heat beam temperature distribution line 132 pre-heated by the preheating laser beam 114 to generate a control signal 144 controlling a laser array 116, the control signal 144 recording deviations from a target temperature in a pre-heated thermal image curve 142 derived from the pre-heat beam temperature distribution line 132 by the infrared detector 110, the control signal 144 compensating for the deviations from the target temperature by signaling increases or decreases in power in individually controlled laser elements 154, 156, 158, 160, 162, 164, 166, 168, 170, & 172 in a laser array 116;

heating the composite tape 122 close before the compaction point 180 with laser array beams 118 from the laser array 116, the laser array 116 being controlled by the control signal 144, the laser array beams 118 on the composite tape 122 close before the compaction point 180 generating a laser array beam temperature distribution line 134, the laser array beam distribution line 134 being achieved on the composite tape 122 immediately before the tape 122 and the substrate 120 reach the compaction point 180; and

bringing the laser array beam temperature distribution line 134 of the heated composite tape 122 to the compaction point 180 and compressing the heated composite tape 122 at the laser array beam temperature distribution line 134 to adhere onto the substrate surface 120 as the compaction roller 124 is applied.

In another embodiment of the method of the present invention, the method further comprises a second pre-heating step and a second heating step; the second pre-heating step includes pre-heating with a second pre-heating laser source 178 the substrate surface 120 to be adhered together with the composite tape 122 simultaneously with the first pre-heating step for pre-heating the composite tape 122; the second heating step includes heating with a second laser array 176 the substrate surface 120 to be adhered together with the composite tape 122 simultaneously with the first heating step for heating the composite tape 122.

In yet another embodiment of the method of the present invention, the laser array 116 for heating the composite tape 122 and the second laser array 176 for heating the substrate surface 120 are combined into a single optical train.

In still another embodiment of the method of the present invention, the first pre-heating laser source 112 and the second pre-heating laser source 178 originate from a single source, and are split and redirected to heat both the composite tape 122 and the substrate 120.

In another embodiment of the method of the present invention, the control signal 144 for the laser array 116 is a combination of a first error signal from the temperature of the pre-heat beam temperature distribution line 132 on the composite tape 122 after the preheat laser beam 114 preheats the composite tape 122 and a second error signal generated from the temperature of the laser array beam temperature distribution line 134 on the composite tape 122 after the laser array beam 118 heats the composite tape 122.

In yet another embodiment of the method of the present invention, the pre-heat laser beam 114 uses any profile that either spans the width of the composite tape 122 or is greater than the width of the composite tape 122.

In still another embodiment of the method of the present invention, the control signal 144 from the thermal image is generated from an infrared imaging detector 110.

In still yet another embodiment of the method of the present invention, the infrared imaging detector 110 has a frame rate that is 200 Hz or less.

The present invention also relates to an automated fiber placement machine comprising

a compaction roller 124 which compresses a heated composite tape 122 onto a substrate 120;

a composite tape feedstock (not pictured) which supplies the composite tape 122 to the compaction roller 124;

a pre-heat laser source 112 which pre-heats with a preheating laser beam 114 the composite tape 122 at least 5 mm before the tape 122 reaches the compaction roller 124, thus producing a pre-heat beam temperature distribution line 132 across the pre-heated composite tape 122;

an infrared thermal image detector 110 which registers an image of the pre-heated temperature distribution line pre-heated by the preheating laser beam 114 to generate a control signal 144 controlling a laser array 116, the control signal 144 recording deviations from a target temperature in a pre-heat thermal image curve 142 derived from the pre-heat beam temperature distribution line 132;

a laser array 116 including individually controlled laser elements 154, 156, 158, 160, 162, 164, 166, 168, 170, & 172 which heat the composite tape 122 close before the compaction point 180, the control signal 144 signaling to increase or decrease power in the individually controlled laser elements 154, 15e, 158, 160, 162, 164, 166, 168, 170 & 172; and

a substrate on which the heated composite tape 122 is compressed by the compaction roller 124 at the compaction point 180.

In another embodiment of the machine of the present invention, the machine further comprises a second pre-heating laser source 178 and a second laser array 176, both of which are used to pre-heat and subsequently to heat the substrate surface 120 that the composite tape 122 is being deposited onto at the compaction point 180.

In yet another embodiment of the machine of the present invention, the laser array 116 for heating the composite tape 122 and the second laser array 176 for heating the substrate surface 120 are combined into a single optical train.

In still another embodiment of the machine of the present invention, the first pre-heating laser source 112 and the second pre-heating laser source 178 originate from a single source, and is split and redirected to heat both the composite tape 122 and the substrate 120.

In still yet another embodiment of the machine of the present invention, the control signal 144 for the laser array 116 is a combination of a first error signal from the temperature of the pre-heat beam temperature distribution line 132 on the composite tape 122 after the preheat laser beam 114 preheats the composite tape 122 and a second error signal generated from the temperature of the laser array beam temperature distribution line 134 on the composite tape 122 after the laser array beam 118 heats the composite tape 122.

In another embodiment of the machine of the present invention, the pre-heat beam uses any profile that either spans the width of the composite tape 122 or is greater than the width of the composite tape 122.

In yet another embodiment of the machine of the present invention, the infrared imaging detector 110 has a frame rate that is 200 Hz or less.

While several embodiments have been described in detail, it will be apparent to those skilled in the art that the disclosed embodiments may be modified. Therefore, the foregoing description is to be considered exemplary rather than limiting.

What is claimed is:

1. A method of making a composite part by automated fiber placement with a compaction roller, comprising the steps of:
pre-heating a composite tape to be adhered to a substrate surface by beaming with a pre-heating laser source a pre-heating laser beam at least 5 mm before the composite tape reaches a compaction point with the compaction roller, the pre-heating producing a pre-heat beam temperature distribution line across the pre-heated composite tape;
registering with an infrared detector an image of the pre-heat beam temperature distribution line pre-heated by the preheating laser beam to generate a control signal controlling a laser array, the control signal recording deviations from a target temperature in a pre-heated thermal image curve derived from the pre-heat beam temperature distribution line by the infrared detector, the control signal compensating for the deviations from the target temperature by signaling increases or decreases in power in individually controlled laser elements in a laser array;
heating the composite tape close before the compaction point with laser array beams from the laser array, the laser array being controlled by the control signal, the laser array beams on the composite tape close before the compaction point generating a laser array beam temperature distribution line, the laser array beam distribution line being achieved on the composite tape immediately before the tape and the substrate reach the compaction point; and
bringing the laser array beam temperature distribution line of the heated composite tape to the compaction point and compressing the heated composite tape at the laser array beam temperature distribution line to adhere onto the substrate surface as the compaction roller is applied.

2. The method of claim 1, wherein the method further comprises a second pre-heating step and a second heating step; the second pre-heating step includes pre-heating with a second pre-heating laser source the substrate surface to be adhered together with the composite tape simultaneously with the first pre-heating step for pre-heating the composite tape 122; the second heating step includes heating with a second laser array 176 the substrate surface 120 to be adhered together with the composite tape 122 simultaneously with the first heating step for heating the composite tape 122.

3. The method of claim 2, wherein the laser array for heating the composite tape and the second laser array for heating the substrate surface are combined into a single optical train.

4. The method of claim 2, wherein the first pre-heating laser source and the second pre-heating laser sources originate from a single source, and are split and redirected to heat both the composite tape and the substrate.

5. The method of claim 1, wherein the control signal 144 for the laser array 116 is a combination of a first error signal from the temperature of the pre-heat beam temperature distribution line 132 on the composite tape 122 after the preheat laser beam 114 preheats the composite tape 122 and a second error signal generated from the temperature of the laser array beam temperature distribution line 134 on the composite tape 122 after the laser array beam 118 heats the composite tape 122.

6. The method of claim 1, wherein the pre-heat laser beam uses any profile that either spans the width of the composite tape or is greater than the width of the composite tape.

7. The method of claim 1, wherein the control signal from the thermal image is generated from an infrared imaging detector.

8. The method of claim 1, wherein the infrared imaging detector has a frame rate that is 200 Hz or less.

9. An automated fiber placement machine comprising
a compaction roller which compresses a heated composite tape onto a substrate;
a composite tape feedstock (not pictured) which supplies the composite tape to the compaction roller;
a pre-heat laser source which pre-heats with a preheating laser beam the composite tape at least 5 mm before the tape reaches the compaction roller, thus producing a pre-heat beam temperature distribution line across the pre-heated composite tape;
an infrared thermal image detector which registers an image of the pre-heat beam temperature distribution line pre-heated by the preheating laser beam to generate a control signal controlling a laser array, the control signal recording deviations from a target temperature in a pre-heated thermal image curve derived from the pre-heat beam temperature distribution line;
a laser array including individually controlled laser elements which heat the composite tape close before the compaction point, the control signal signaling to increase or decrease power in the individually controlled laser elements; and
a substrate on which the heated composite tape is compressed by the compaction roller at the compaction point.

10. The machine of claim 9, further comprising a second pre-heating laser source and a second laser array, both of which are used to pre-heat and subsequently to heat the substrate surface that the composite tape is being deposited onto at the compaction point.

11. The machine of claim 10, wherein the laser array for heating the composite tape and the second laser array for heating the substrate surface are combined into a single optical train.

12. The machine of claim 10, wherein the first pre-heating laser source and the second pre-heating laser source originate from a single source, and is split and redirected to heat both the composite tape and the substrate.

13. The machine of claim 9, wherein the control signal for the laser array is a combination of a first error signal from the temperature of the pre-heat beam temperature distribution line on the composite tape after the preheat laser beam preheats the composite tape and a second error signal generated from the temperature of the laser array beam temperature distribution line on the composite tape after the laser array beam heats the composite tape.

14. The machine of claim 9, wherein the pre-heat beam uses any profile that either spans the width of the composite tape or is greater than the width of the composite tape.

15. The machine of claim 9, wherein the infrared imaging detector has a frame rate that is 200 Hz or less.
